(19) United States
(12) Patent Application Publication
(10) Pub. No.: US 2007/0090140 A1
(43) Pub. Date: Apr. 26, 2007

(54) PACKING APPARATUS

(76) Inventor: Louis Chuang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/163,620

(22) Filed: Oct. 25, 2005

(51) Int. Cl. B62J 9/00; A45C 15/00

(52) U.S. Cl. 224/427; 224/585

(57) ABSTRACT

There is shown a packing apparatus including a rack for easy attachment to the seat tube of a bicycle and a bag for stable installation on the rack. The rack includes a telescopic beam and a body defining a space for receiving the telescopic beam. The telescopic beam is connected to the seat tube in a detachable manner. The body supports the bag.

### BACKGROUND OF INVENTION

1. Field of Invention

The present invention relates to a packing apparatus that can be used on a bicycle.

2. Related Prior Art

There are various bags, sacks and packs (hereinafter called “bag” or “bags”). The bags can be carried in hands or on shoulders. A rider carries a bag in a hand or on one or two shoulders. This causes an extra burden on the rider. The rider has to adjust the position of the bag from time to time. The rider might lose balance and get hurt and/or hurt others. The rider might be distracted and get hurt and/or hurt others.

If the bicycle includes a rear rack, the rider may put the bag on the rear rack. The rider may have the bag lie on the rear rack. It is however hard to put the bag on the rear rack stably since the rear rack is small in area and the center of the gravity of the bag often moves beyond the rear rack so that the bag tilts and hence falls from the rear rack. This distracts the rider and might cost the safety of the rider and others.

The rider may alternatively put the bag upright on the rear rack. It is also hard to put the upright bag on the rear rack stably since the center of the gravity of the bag often moves beyond the rear rack so that the bag tilts and hence falls from the rear rack. This distracts the rider and might cost the safety of the rider and others. Moreover, the upright bag troubles the rider in mounting and dismounting from the bicycle. In addition, the seat of the bicycle is often lifted in order to better support the upright bag. This might cause discomfort for a short rider.

The present invention is therefore intended to obviate or at least alleviate the problems encountered in prior art.

### SUMMARY OF INVENTION

According to the present invention, a packing apparatus includes a rack for easy attachment to the seat tube of a bicycle and a bag for stable installation on the rack. The rack includes a telescopic beam and a body defining a space for receiving the telescopic beam. The telescopic beam is connected to the seat tube in a detachable manner. The body supports the bag.

The primary advantage of the packing apparatus of the present invention is to enable a rider to carry things on the bicycle in a hand-free and carefree manner.

In a specific aspect, the rack includes a body for supporting the bag and a telescopic beam for attachment to the seat tube. The telescopic beam is connected to the body.

Another advantage of the packing apparatus according to this aspect of the present invention is adaptability to various bicycles because of the telescopic beam.

Other advantages and novel features of the present invention will become more apparent from the following detailed description referring to the attached drawings.

### BRIEF DESCRIPTION OF DRAWINGS

The present invention will be described through illustration of four embodiments referring to the drawings.

FIG. 1 is a perspective view of a packing apparatus according to the first embodiment of the present invention.

FIG. 2 is another perspective view of the packing apparatus of FIG. 1

FIG. 3 is a perspective of a rack used in the packing apparatus shown in FIG. 1.

FIG. 4 is an exploded view of the rack shown in FIG. 3.

FIG. 5 is a cross-sectional view taken along a line A-A in FIG. 3.

FIG. 6 is similar to FIG. 5 but shows the rack in another position.

FIG. 7 is a side view of the packing apparatus of FIG. 1 to be attached to a bicycle.

FIG. 8 is similar to FIG. 7 but shows the packing apparatus attached to the bicycle.

FIG. 9 is similar to FIG. 8 but shows the packing apparatus further tied to the bicycle.

FIG. 10 is a perspective of a rack according to the second embodiment of the present invention.

FIG. 11 is an exploded view of the rack shown in FIG. 10.

FIG. 12 is a perspective of a rack according to the third embodiment of the present invention.

FIG. 13 is an exploded view of the rack shown in FIG. 12.

FIG. 14 is a side view of a packing apparatus according to the fourth embodiment of the present to be attached to a bicycle.

FIG. 15 is similar to FIG. 14 but shows the packing apparatus attached to the bicycle.

### DETAILED DESCRIPTION OF EMBODIMENTS

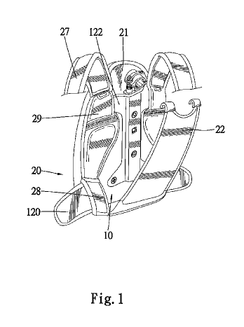

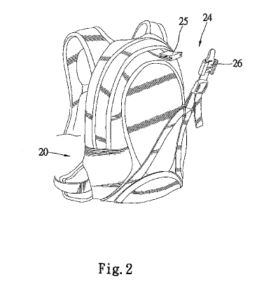

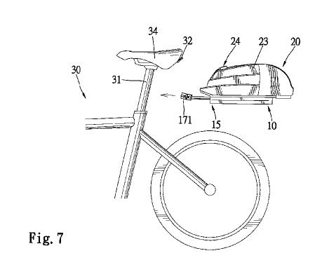

Referring to FIGS. 1 and 2, there is shown a packing apparatus according to a first embodiment of the present invention. The packing apparatus includes a rack 10 and a bag 20. The rack 10 can be attached to a bicycle 30 (FIGS. 7 through 9) firmly. The bag 20 can be attached to the rack 10 firmly. Hence, the packing apparatus can be installed on the bicycle 30 firmly.

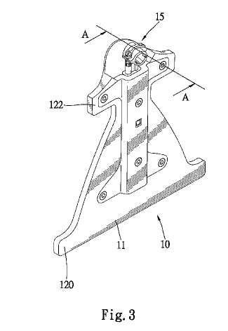

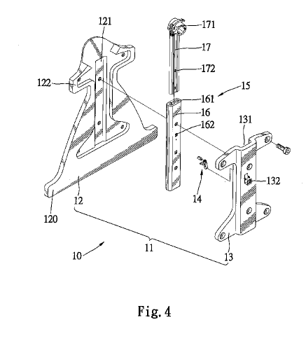

Referring to FIGS. 3 and 4, the rack 10 includes a body 11 and a telescopic beam 15 connected to the body 11. The body 11 includes a platform 12 and a cover 13 attached to the platform 12 by means of screws (not numbered).

The platform 12 includes two lower fins 120 extending opposite to each other and two upper fins 122 extending opposite to each other. The platform 12 defines a cavity (not numbered) for receiving the cover 13 and a groove 121 in the floor of the cavity.

The cover 13 defines a groove 131 corresponding to the groove 121 and an aperture 132 in communication with the groove 131. When the cover 13 is attached to the platform 11, the grooves 131 and 121 together define a composite space for receiving the telescopic beam 15. A switch 14 is installed in the aperture 132.

The telescopic beam 15 includes a tube 16 put in the composite space in a stationary manner and a rod 1 7 put in the space 161 of the tube 16 in a movable manner. The tube 16 defines an aperture 162 in communication with the space 161. When the tube 16 is put in the composite space, the aperture 162 will be in communication with the aperture 132.

The rod 17 includes a quick release element 171 installed at an end and a plurality of holes 172 defined therein. When the rod 17 is put in the tube 16, selective one of the holes 172 can be in communication with the apertures 162 and 132. The switch 14 can be put into selective one of the holes 172 in order to retain the rod 17 in selective one of several positions relative to the tube 16.

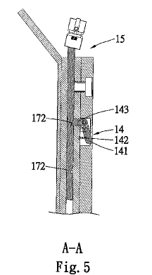

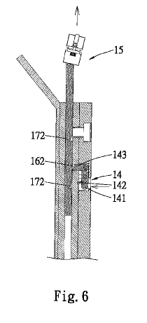

Referring to FIGS. 5 and 6, the switch 14 includes a lever 141 pivotally installed in the aperture 132, a latch 143 pivotally connected to the lever 141 and put into selective one of the holes 172 from the aperture 132 through the aperture 162 and a spring 142 compressed between the lever 161 and the tube 16.

Referring to FIG. 5, normally, the lever 161 is lifted by means of the spring 162 so that the latch 163 is kept in selective one of the holes 172 so that the rod 17 is retained in selective one of the positions relative to the tube 16.

Referring to FIG. 6, the lever 161 can be pushed down so that the latch 163 is moved from the holes 172 so that the rod 17 can be moved relative to the tube 16.

Referring to FIGS. 1 and 2, the bag 20 includes a first side 21 and a second side 23 opposite to the first side 21. On the first side 21 of the bag 20 are formed two large straps 27 for holding on to a user's shoulders, two lower small straps 28 for holding on to the lower fins 120, two upper small straps 29 for holding on to the upper fins 122 and a mudguard 22 for fending the bag 20 from mud.

On the second side 23 of the bag 20 is provided a buckling device 24. The buckling device 24 includes a first buckle 25 and a second buckle 26 for engagement with the first buckle 25. The buckling device 24 can be any appropriate buckling device.

Referring to FIG. 7, the bicycle 30 includes a seat tube 31 and a seat 34 installed on the seat tube 34. To the seat 34 is attached a buckle 32 similar to the buckle 25. The packing pack is about to be attached to the bicycle 30.

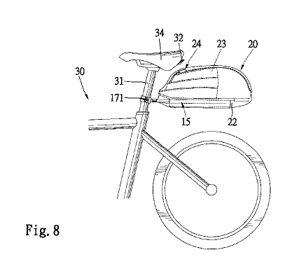

Referring to FIG. 8, the quick release element 171 is engaged with the seat tube 31. The engagement is easy and quick because of the nature of the quick release element 171.

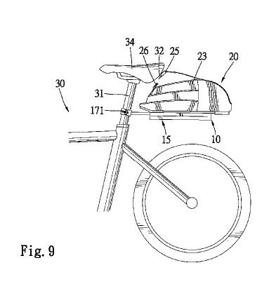

Referring to FIG. 9, the buckle 26 is disengaged from the buckle 25. The buckle 26 is engaged with the buckle 32. Thus, the packing device is attached to the seat 34.

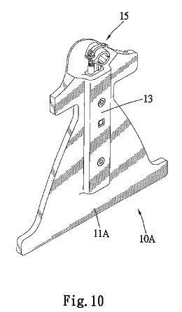

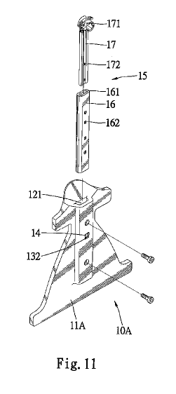

Referring to FIGS. 10 and 11, there is shown a rack 10A according to a second embodiment of the present invention. The rack 10A is similar to the rack 10 except including a body 11A instead of the body 11. The body 11A is made through merging the platform 12 with the cover 13.

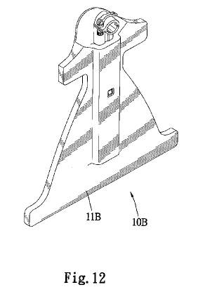

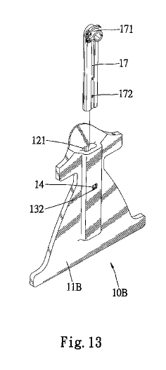

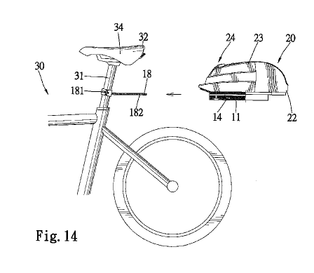

Referring to FIGS. 12 and 13, there is shown a rack 10B according to a third embodiment of the present invention. The rack 10B is similar to the rack 10A except including a body 11B instead of the body 11A. The body 11B is made through merging the body 11 A with the tube 16.

The present invention has been described via the detailed illustration of the embodiments. Those skilled in the art can derive variations from the embodiments without departing from the scope of the present invention. Therefore, the embodiments shall not limit the scope of the present invention defined in the claims.

What is claimed is:

1. A packing apparatus comprising: a rack comprising a telescopic beam for easy attachment to the seat tube of a bicycle and a body defining a space for receiving the telescopic beam; and a bag for stable installation on the body.

2. The packing apparatus according to claim 1 wherein the telescopic beam comprises a tube installed in the space in a stationary manner and a rod put in the tube in a movable manner.

3. The packing apparatus according to claim 2 comprising a switch for controlling the movement of the rod in the tube.

4. The packing apparatus according to claim 3 wherein the rod defines a plurality of holes for receiving the switch, wherein the tube defines an aperture for receiving the switch, wherein the body defines an aperture for receiving the switch.

5. The packing apparatus according to claim 4 wherein the switch comprises a latch for insertion in selective one of the holes in order to retain the rod in selective one of positions relative to the tube.

6. The packing apparatus according to claim 5 wherein the switch comprises a lever pivotally connected to the latch so that the lever can be pushed in order to move the latch from the holes so that the rod can be moved in the tube.

7. The packing apparatus according to claim 6 wherein the switch comprises a spring compressed between the lever and the tube so that the latch is pushed toward the rod.

8. The packing apparatus according to claim 2 wherein the tube is merged with the body.

9. The packing apparatus according to claim 1 wherein the body comprises a platform and a cover attached to the platform, thus sandwiching the telescopic beam.

10. The packing apparatus according to claim 9 wherein the platform defines a groove, wherein the cover defines a groove, wherein the groove of the platform and the groove of the cover together define the space for receiving the telescopic beam.

11. The packing apparatus according to claim 1 wherein the telescopic beam comprises a quick release element for attachment to the seat tube.

12. The packing apparatus according to claim 1 wherein the body comprises two fins extending opposite to each other, wherein the bag comprises two straps for holding on to the fins.

13. The packing apparatus according to claim 12 wherein the bag comprises a buckle for engagement with a buckle installed on the bicycle in order to install the packing apparatus on the bicycle more stably.

14. A packing apparatus comprising:
a rack comprising a rod for easy attachment to the seat tube of a bicycle and a body defining a space for receiving the rod in a telescopic manner; and
a bag for stable installation on the body.

15. The packing apparatus according to claim 14 comprising a switch for controlling the movement of the rod in the space.

16. The packing apparatus according to claim 15 wherein the rod defines a plurality of holes for receiving the switch, wherein the body defines an aperture for receiving the switch.

17. The packing apparatus according to claim 16 wherein the switch comprises a latch for insertion in selective one of the holes in order to retain the rod in selective one of positions relative to the tube.

18. The packing apparatus according to claim 17 wherein the switch comprises a lever pivotally connected to the latch so that the lever can be pushed in order to move the latch from the holes so that the rod can be moved in the tube.
